(19) United States
(12) Patent Application Publication
(10) Pub. No.: US 2011/0050953 A1
(43) Pub. Date: Mar. 3, 2011

(54) METHOD OF SETTING IMAGE ASPECT RATIO ACCORDING TO SCENE RECOGNITION AND DIGITAL PHOTOGRAPHING APPARATUS FOR PERFORMING THE METHOD

(75) Inventors: Hye-jin Kim, Seoul (KR); Jun-ho Choi, Seoul (KR)

(73) Assignee: Samsung Electronics Co., Ltd., Suwon-si (KR)

(21) Appl. No.: 12/874,296

(22) Filed: Sep. 2, 2010

(30) Foreign Application Priority Data
Sep. 2, 2009 (KR) 10-2009-0082559

(51) Int. Cl. H04N 5/228; H04N 5/76

(52) U.S. Cl. 348/231.1; 348/222.1; 348/E05.024

(57) ABSTRACT

A method of setting a ratio of an input image according to scene recognition and a digital photographing apparatus for performing the method, the method including: generating an input image; recognizing a scene from the input image; and setting a ratio of the input image according to the recognized scene. A digital photographing apparatus that sets a ratio of an input image according to scene recognition, the apparatus including an image generating unit configured to generate an input image; a scene recognition unit configured to recognize a scene from the input image; and an image aspect ratio setting unit configured to set an aspect ratio of the input image according to the recognized scene.

### CROSS-REFERENCE TO RELATED PATENT APPLICATION

This application claims the benefit of Korean Patent Application No. 10-2009-0082559, filed on Sep. 2, 2009, in the Korean Intellectual Property Office, the entire contents of which is incorporated herein by reference.

### BACKGROUND

1. Field of the Invention

The invention relates to a method of setting an image aspect ratio according to scene recognition and a digital photographing apparatus for performing the method.

2. Description of the Related Art

Generally, digital photographing apparatuses such as digital cameras, camcorders or video cameras provide a variety of image ratios.

An image ratio that is widely used in digital photographing apparatuses is an aspect ratio (vertical-to-horizontal ratio of the image) of 4:3. The aspect ratio of 4:3 is employed as a basic image ratio in digital photographing apparatuses including various displays. An image ratio that is an aspect ratio of 3:2 used in printing or publishing is employed as a standard image ratio for film cameras. The aspect ratio of 3:2 has a longer width ratio than a width ratio of the aspect ratio of 4:3 and thus may be more pleasing to the eye. In addition, an image ratio that is an aspect ratio of 16:9, which is widely used in various video devices including high-definition televisions (HDTVs) and entitled wide vision, has a longer width ratio than a width ratio of the aspect ratio of 3:2. The image ratio of 16:9 is widely used in video devices such as TVs and recently, is widely used in digital photographing apparatuses such as digital cameras.

Often, in digital photographing apparatuses, when a user selects an image ratio, all the subsequent images are captured with the selected aspect ratios. Additionally, images displayed from storage may be displayed with the selected aspect ratio. Thus, a user may have to change an image ratio for each individual image before photographing or displaying the image.

Additionally, an image may be stored as a plurality of images having different aspect ratios, which may make it difficult to manage all the image files of the same image.

### SUMMARY

Therefore, there is a need in the art for methods of setting an image aspect ratio according to scene recognition by which a landscape-oriented scene and a non-landscape-oriented scene are recognized and an image aspect ratio is set for each of the landscape-oriented scene and the non-landscape-oriented scene, and a digital photographing apparatus for performing the method.

According to an aspect of the invention, there is provided a method of setting a ratio of an input image according to scene recognition, the method including: generating an input image; recognizing a scene from the input image; and setting a ratio of the input image based on the recognized scene.

In a first scene that is a landscape-oriented scene such as a landscape as an outdoor landscape, a night view, and a backlight landscape in which there is no person, the setting of the ratio of the input image may include setting the ratio of the input image to an aspect ratio of 16:9 based on a landscape-oriented scene.

In a second scene that is a non-landscape-oriented scene such as a person as a subject, a night view portrait as a subject outdoors at night, a backlight portrait as a subject under backlight conditions, a macro in which a subject is close to the imaging unit, and a macro text in which a short-distance character is a subject, the setting of the ratio of the input image may include setting the ratio of the input image to an aspect ratio of 4:3 based on a non-landscape-oriented scene.

The method may further include displaying the input image on a display unit based on the set aspect ratio of the input image.

The method may further include setting a size of the input image based on the set aspect ratio of the input image.

The setting of the size of the input image may include: checking a storage space of a storage unit; as a result of the checking, if it is determined that the storage space of the storage unit is sufficient, setting the size of the input image with respect to the set aspect ratio of the input image to a maximum value and as a result of the checking, if it is determined that the storage space of the storage unit is insufficient, setting the size of the input image with respect to the set aspect ratio of the input image to a minimum value. The maximum value may represent high resolution, and the minimum value may represent low resolution.

The method may further include performing photographing according to the set aspect ratio of the input image and the size of the input image.

According to other embodiments of the invention, there is provided a digital photographing apparatus that sets a ratio of an input image according to scene recognition, the apparatus including: an image generating unit for generating an input image; a scene recognition unit for recognizing a scene from the input image; and an image aspect ratio setting unit for setting an aspect ratio of the input image based on the recognized scene.

In a first scene that is a landscape-oriented scene such as a landscape as an outdoor landscape, a night view, and a backlight landscape in which there is no person, the image aspect ratio setting unit may set the aspect ratio of the input image to an aspect ratio of 16:9 based on a landscape-oriented scene.

In a second scene that is a non-landscape-oriented scene such as a person as a subject, a night view portrait as a subject outdoors at night, a backlight portrait as a subject under backlight conditions, a macro in which a subject is close to the imaging unit, and a macro text in which a short-distance character is a subject, the image aspect ratio setting unit may set the aspect ratio of the input image to an aspect ratio of 4:3 based on a non-landscape-oriented scene.

The apparatus may further include a display controller for displaying the input image on a display unit based on the set aspect ratio of the input image.

The apparatus may further include an image size setting unit for setting a size of the input image based on the set aspect ratio of the input image.

The apparatus may further include a storage space checking unit for checking a storage space of a storage unit, wherein, as a result of the checking, if it is determined that the storage space of the storage unit is sufficient, the size of the input image with respect to the set aspect ratio of the input image is set to a maximum value and as a result of the checking, if it is determined that the storage space of the storage unit is insufficient, the size of the input image with respect to the set aspect ratio of the input image is set to a minimum value.

### BRIEF DESCRIPTION OF THE DRAWINGS

The above and other features and advantages of embodiments of the invention will become more apparent by describing in detail exemplary embodiments thereof with reference to the attached drawings in which:

FIG. 1 is a block diagram of a digital camera, that is a digital photographing apparatus, that is capable of setting an image aspect ratio according to scene recognition according embodiments of the invention;

FIGS. 2 through 4 are block diagrams of a digital signal processor (DSP) of the digital camera of FIG. 1, according to embodiments of the invention;

FIG. 5 is a flowchart illustrating a method of setting an image aspect ratio according to scene recognition, performed by the digital camera of FIG. 1, according embodiments of the invention;

FIG. 6 is a flowchart illustrating the method of setting the image aspect ratio according to scene recognition as illustrated in FIG. 5, according to embodiments of the invention;

FIGS. 7A, 7B, 7C, 7D, 8A, 8B, 8C and 8D illustrate images having adjusted ratios according to embodiments of the invention; and

FIG. 9 is a flowchart illustrating a method of setting an image aspect ratio according to scene recognition, performed by the digital camera of FIG. 1, according to embodiments of the invention.

### DETAILED DESCRIPTION OF THE INVENTION

Hereinafter, the invention will be described in detail by explaining exemplary embodiments of the invention with reference to the attached drawings.

A digital camera, that is, a digital photographing apparatus, according to embodiments of the invention will be described. However, the invention is not limited thereto, and the digital photographing apparatus may be a digital device such as a camera phone in which a digital image signal processor is installed, a personal digital assistant (PDA), a portable multimedia player (PMP), a television (TV) or a digital picture frame.

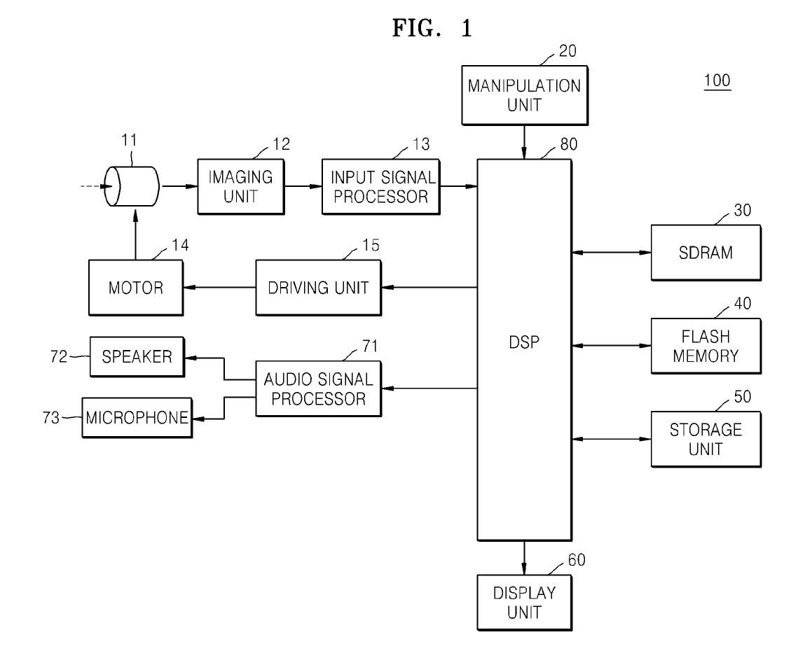

FIG. 1 is a block diagram of a digital camera 100, that is, a digital photographing apparatus, that is capable of setting an image aspect ratio according to scene recognition according to embodiments of the invention. Referring to FIG. 1, the digital camera 100 according to embodiments of the invention includes an optical unit 11 that inputs an optical signal from a subject, an imaging unit 12 that converts the optical signal input by the optical unit 11 into an electrical signal, and an input signal processor 13 that reduces noise of the electrical signal supplied by the imaging unit 12 and converts the electrical signal into a digital signal. The digital camera 100 further includes a motor 14 that drives the optical unit 11 and a driving unit 15 that controls an operation of the motor 14. The digital camera 100 may further include a manipulation unit 20 that inputs a signal input by user manipulation, a synchronous dynamic random access memory (SDRAM) 30 in which data of an input image, data used in performing calculation, and the result of processing are temporarily stored, a flash memory 40 in which methods for performing operations of the digital camera 100, and setting data, are stored, and a storage unit 50 that includes an SD/CF/SM card as a recording device in which an image file is stored. Also, the digital camera 100 may further include a display unit 60 that includes a liquid crystal display (LCD) as a display. Also, the digital camera 100 may further include an audio signal processor 71 that converts sound into a digital signal or converts a digital signal of a sound source into an analog signal or generates an audio file, a speaker 72 that outputs sound, and a microphone 73 that inputs sound. The digital camera 100 further includes a digital signal processor (DSP) 80 that controls an operation of the digital camera 100.

Each of the elements of the digital camera 100 of FIG. 1 will be described in detail below.

The optical unit 11 may include a lens unit for condensing the optical signal, an iris diaphragm that adjusts the amount of the optical signal (the amount of light), and a shutter that controls inputting of the optical signal. The lens unit includes a zoom lens that increases or decreases a viewing angle according to a focal length, and a focusing lens that focuses on a subject. The lens unit may include one zoom lens or focusing lens or a plurality of lenses. The shutter may be a mechanical shutter that controls incidence of light by moving a shutter. Also, instead of an additional shutter, supply of an electrical signal to the imaging unit 12 may be controlled.

The motor 14 that drives the optical unit 11 may adjust the position of the lens unit, open and close the iris diaphragm, and drive the shutter so as to perform automatic focusing, automatic exposure correction, iris diaphragm control, zoom changing, and focus changing.

The motor 14 is controlled by the driving unit 15. The driving unit 15 controls an operation of the motor 14 according to a control signal input by the DSP 80.

The imaging unit 12 forms an image of the subject by receiving the optical signal input by the optical unit 11. The imaging unit 12 may be a complementary metal oxide semiconductor (CMOS) sensor array or a charge coupled device (CCD) sensor array.

The input signal processor 13 may include an analog-to-digital (A/D) converter that converts the electrical signal as an analog signal supplied from the CCD sensor array into a digital signal. Also, the image signal processor 13 may further include a circuit for performing signal processing such as gain control or waveform shaping on the electrical signal supplied from the imaging unit 12.

The manipulation unit 20 may include a member for performing settings required when a user manipulates the digital camera 10 or photographing is performed. For example, the manipulation unit 20 may be a button, a key, a touch panel, a touch screen or a dial and may input a user control signal used in power on/off, photographing start/stop, playback start/stop/search, driving of an optical system, mode conversion, menu manipulation, and optional manipulation.

Raw data (RGB data) of an image supplied by the input signal processor 13 may be temporarily stored in the SDRAM 30, and predetermined image signal processing may be performed on the temporarily-stored raw data (RGB data) according to calculations performed by the DSP 80, or the raw data (RGB data) may be transmitted to other elements.

Also, data that is used by the methods for performing operations of the digital camera 100 stored in the flash memory 40 may be converted into executable data and may be temporarily stored in the SDRAM 30. The data stored in the SDRAM 30 may be calculated by the DSP 80 so that operations may be performed according to the algorithm for performing operations of the digital camera 100. Furthermore, image data that is obtained by decompressing the image file stored in the flash memory 40 may be temporarily stored in the SDRAM 30. The temporarily-stored image data may be transmitted to the LCD as the display unit 60 so that the LCD as the display unit 60 may display a predetermined image. A volatile memory that temporarily memorizes data during power supply may be used as the SDRAM 30, and a semiconductor device in which a plurality of memory devices are integrated, may also be used as the SDRAM 30.

Data used in executing an operating system (OS) for operating the digital camera 100, applications, and the algorithm for performing operations of the digital camera 100 may be stored in the flash memory 40. The flash memory 40 may be a nonvolatile memory such as a read only memory (ROM).

The image file that is generated by compressing the image data supplied by the input signal processor 13 may be stored in the storage unit 50. The storage unit 50 may be a memory installed in the digital camera 100 or a memory installed outside the digital camera 100. The storage unit 50 may be a hard disk driver (HDD), an optical disc, a magneto-optical disc or a hologram memory.

The display unit 60 may display an image corresponding to the image data supplied by the input signal processor 13 in real time or may display an image corresponding to image data decompressed from the image file stored in the storage unit 50. The display unit 60 may be an LCD. However, embodiments of the invention are not limited thereto, and the display unit 60 may be an organic light-emitting display device or an electrophoresis display device.

The audio signal processor 71 converts the digital signal from the sound source supplied by the DSP 80 into sound, amplifies the signal and transmits the amplified signal to the speaker 72, and the speaker 72 outputs the sound. The audio signal processor 71 may input sound through the microphone 73, may compress the sound converted into the digital signal and may generate an audio file. The audio signal processor 71 may transmit the amplified signal to the DSP 80 so that the DSP 80 may perform calculations on the amplified signal.

The DSP 80 may perform image signal processing for improving the quality of an image, such as noise reduction in input image data, Gamma correction, color filter array interpolation, color matrix correction, color correction, and color enhancement. Also, the DSP 80 may generate an image file by compressing image data that is generated during the image signal processing for improving the quality of an image, or may decompress the image data from the image file. The image data is compressed in a reversible or a non-reversible format. As an example of an appropriate format for compressing the image data, the image data can be compressed in a joint photographic experts group (JPEG) format such as JPEG 2000. The DSP 80 may also perform unclearness processing, color processing, blur processing, edge emphasis processing, image interpretation processing, image recognition processing, image effect processing, etc. The image recognition processing may include scene recognition processing. The DSP 80 may also perform display image signal processing so as to display the operating state of the digital camera 100 or the information about an image captured by the digital camera 100 on the display unit 160. For example, the DSP 80 may perform brightness level adjustment, color correction, contrast adjustment, contour emphasis adjustment, screen division processing, and character image generation and synthesis processing.

The DSP 80 performs the above-described image signal processing and may control each element of the digital camera 100 according to the results of processing. Also, the DSP 80 may control each element of the digital camera 100 according to a user's control signal input via the manipulation unit 20. The method for performing the image signal processing is stored in the flash memory 40, and data that is used in constituting the method may be converted into executable data and may be temporarily stored in the SDRAM 30 and thus may be calculated by the DSP 80.

Also, the DSP 80 controls each element of the digital camera 100 to display a scene recognized in a scene recognition mode. The DSP 80 may set the ratio of an image based on the scene recognized in the scene recognition mode and may check a storage space of the storage unit 50 to adjust the size of the image.

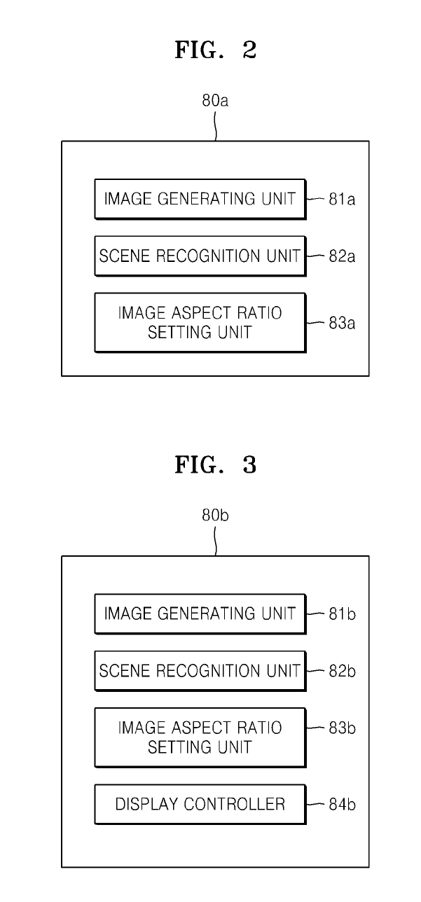

Operations to be controlled by the DSP 80 will be described in detail with reference to FIGS. 2 through 4.

FIG. 2 is a block diagram of a DSP 80a of the digital camera 100 of FIG. 1, according to embodiments of the invention. Referring to FIG. 2, the DSP 80a may include an image generating unit 81a, a scene recognition unit 82a, and an image aspect ratio setting unit 83a.

The image generating unit 81a may perform at least one type of image signal processing from among various types of image signal processing, such as noise reduction in the image data input by the input signal processor 13, gamma correction, color filter array interpolation, color matrix processing, color correction, and color enhancement, so as to generate an input image.

The input image generated by the image generating unit 81a may be displayed on the display unit 60 as a live view image.

The scene recognition unit 82a recognizes a scene such as a landscape or a portrait from the input image generated by the image generating unit 81a. The scene recognition unit 82a may extract an edge from the input image to which a high frequency pass filter is applied, and may check the position and size of a subject from the result of extraction to recognize the scene. Also, the scene recognition unit 82a may recognize the scene such as a landscape or a portrait by using distribution of histograms according to channels of the input image or color information in a color space of the input image. Embodiments of the invention are not limited thereto, and scene recognition may be performed in various ways.

In embodiments, the scene recognition unit 82a may recognize a landscape-oriented scene (first scene) and a non-landscape-oriented scene (second scene). In embodiments, the digital camera 100 of FIG. 1 may recognize at least 8 scenes as shown in Table 1 below.

As shown in Table 1, the landscape-oriented scene may include a landscape as an outdoor landscape, a night view, and a backlight landscape in which there is no person. The non-landscape-oriented scene may include a person as a subject, a night view portrait as a subject outdoors at night, a backlight portrait as a subject under backlight conditions, a macro in which a subject is close to the imaging unit 12 of FIG. 1, and a macro text in which a short-distance character is a subject.

TABLE 1

| Classification 1 | Classification 2 | Contents |
|---|---|---|
| Landscape-oriented | Landscape | Photographing outdoor landscape |
| scene | Night view | Photographing night view |
| | Backlight | Photographing backlight landscape |
| | | in which there is no person |
| Non-landscape- | Portrait | Photographing person |
| oriented scene | Night view portrait | Photographing person outdoors at night |
| | Backlight portrait | Photographing person under backlight |
| | | conditions |
| | Macro | Close photographing |
| | Macro text | Photographing character at short-distance |

The image aspect ratio setting unit 83a sets the ratio of the input image corresponding to the recognized scene.

In embodiments, in the case of the landscape-oriented scene, the ratio of the input image is set to an aspect ratio of 16:9, and in the case of the non-landscape-oriented scene, the ratio of the input image is set to an aspect ratio of 4:3.

In embodiments, the input image may be displayed on the display unit 60 in a live view mode (photographing mode). In this case, the user may check the type of the scene recognized from the input image displayed on the display unit 60 and a scene ratio of the input image displayed on the display unit 60 before photographing.

In other embodiments, the input image may be displayed on the display unit 60 in a quick view mode after photographing. Also, the input image may be displayed on the display unit 60 when the user plays back the image stored in the storage unit 50 after photographing in a playback mode. Also, the input image may be an image displayed on an external monitor (not shown) when the digital camera 100 and the external monitor or a printing device (not shown) are connected to each other, or may be an image printed by the printing device. In this case, the user may check the type of the scene recognized from the input image and the ratio of the image after photographing.

According to embodiments of the invention, the user may obtain an image having an aspect ratio of 16:9 that is appropriate for viewing of a landscape due to a longer width ratio than a length ratio of the image without changing settings when photographing the landscape-oriented scene.

FIG. 3 is a block diagram of a DSP 80b of the digital camera 100 of FIG. 1, according to embodiments of the invention. Referring to FIG. 3, the DSP 80b may include an image generating unit 81b that generates an input image, a scene recognition unit 82b that recognizes a scene from the input image, an image aspect ratio setting unit 83b that sets the ratio of the image based on the recognized scene, and a display controller 84b that displays the input image on the display unit 60.

The display controller 84b may display the image on the display unit 60 in the live view mode based on the ratio of the image set by the image aspect ratio setting unit 83b.

In embodiments, when the landscape-oriented scene is recognized by the scene recognition unit 82b, the image aspect ratio setting unit 83b sets the ratio of the input image to 16:9. The display controller 84b displays the image on the display unit 60 at the set aspect ratio of 16:9. Also, when the non-landscape-oriented scene is recognized by the scene recognition unit 82b, the image aspect ratio setting unit 83b sets the ratio of the input image to 4:3. In this case, the display controller 84b displays the image on the display unit 60 at the set aspect ratio of 4:3 in the live view mode.

Thus, the user may check the input image having an adjusted aspect ratio as a result of recognizing the input image in the live view mode from the display unit 60. The user may obtain a desired image by adjusting the type of photographing based on the image checked from the display unit 60.

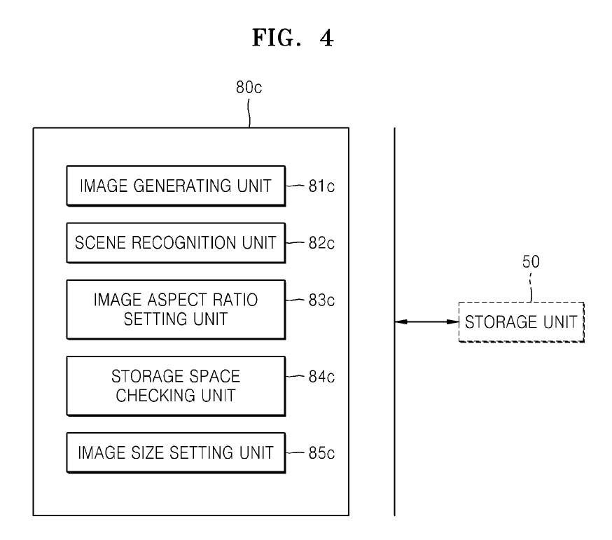

FIG. 4 is a block diagram of a DSP 80c of the digital camera of FIG. 1, according to embodiments of the invention. Referring to FIG. 4, the DSP 80c may include an image generating unit 81c that generates an input image, a scene recognition unit 82c that recognizes a scene from the input image, an image aspect ratio setting unit 83c that sets the aspect ratio of the image based on the recognized scene, a storage space checking unit 84c, and an image size setting unit 85c.

The storage space checking unit 84c checks the storage space of the storage unit 50.

When there is a space in which the image file generated with the set image aspect ratio is to be stored, as a result of checking the storage space, the image size setting unit 85c sets the size of the input image with respect to the set aspect ratio to a maximum value. However, when the storage space of the storage unit 50 in which the set image file is to be stored is insufficient, the image size setting unit 85c sets the size of the input image with respect to the set aspect ratio to a minimum value.

Whether the storage space of the storage unit 50 in which the image file is to be stored is sufficient may be determined by a program that has been already stored in the digital camera 100 of FIG. 1. For example, when the storage space of the storage unit 50 is less than 10%, the digital camera 100 of FIG. 1 may determine that the storage space of the storage unit 50 is insufficient and may set the size of the input image to a minimum value.

For example, as shown in Table 2 below, when the ratio of the input image is set to 4:3 at the non-landscape-oriented scene, the storage space of the storage unit 50 is sufficient, and the size of the input image may be set to a maximum value 4000×3000. In this case, the size of the input image may represent resolution, and the maximum value of the size of the input image may represent a maximum resolution of the digital camera 100 of FIG. 1 that may be applied to the set image aspect ratio.

When the storage space of the storage unit 50 is insufficient, the size of the input image with respect to the set aspect ratio of 4:3 may be set to a minimum value 1024×768. The minimum value of the size of the input image may represent minimum resolution of the digital camera 100 of FIG. 1 that may be applied to the set aspect ratio.

TABLE 2

| | Maximum | . . . | Minimum |
|---|---|---|---|
| Image size (resolution) | 4000 × 3000 | . . . | 1024 × 768 |

For example, in the case of the non-landscape-oriented scene, the aspect ratio of 16:9 is set, and when, as a result of checking performed by the storage space checking unit 84c, the storage space of the storage unit 50 is sufficient, the size of the input image may be set to a maximum size such as 2048×1159.

However, when the storage space of the storage unit 50 is insufficient, the input image may be set to a minimum size such as 1280×720.

Specific values of the above-described image size are just illustrated as examples and may be set according to a resolution or an image size of the digital camera 100 of FIG. 1. Also, the image size may be set to a maximum or minimum value based on the storage space of the storage unit 50 by adjusting the resolution, as described above, or according to a compression ratio of the input image. In other words, when the storage space of the storage unit 50 is sufficient, the compression ratio of the input image may be set to a minimum value, and when the storage space of the storage unit 50 is insufficient, the compression ratio of the input image may be set to a maximum value.

In embodiments, after the ratio of the input image is set according to scene recognition, the size of the input image may be set to a maximum value.

However, when, as a result of checking of the storage space performed by the storage space checking unit 84c, the size of the input image is set to a maximum value, if it is determined that a space in which the image file is to be stored is insufficient, the image size setting unit 85c may set the size of the image to a minimum value.

The capacity of the storage unit 50 may be checked by using the storage space checking unit 84c and the image size setting unit 85c, and the size of the image may be automatically adjusted and set based on the capacity of the storage unit 50. As a result, the user does not need to check the storage unit 50 nor delete the image file by checking whether the image file is stored in the storage unit 50.

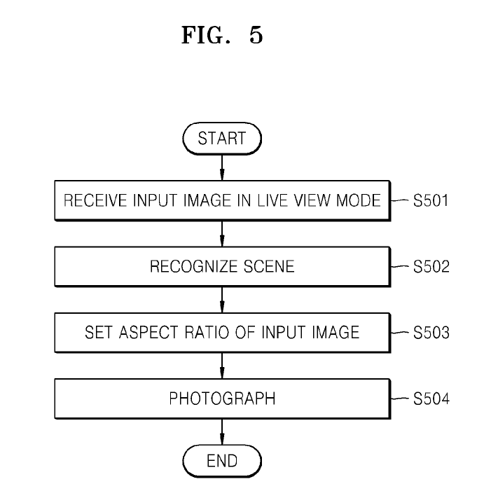

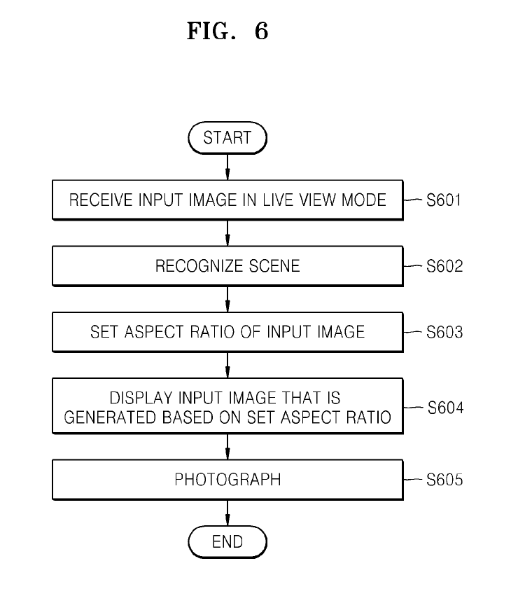

Hereinafter, a method of setting an image aspect ratio according to scene recognition according to other embodiments of the invention will be described with reference to flowcharts of FIGS. 5 and 6.

FIG. 5 is a flowchart illustrating a method of setting an image aspect ratio according to scene recognition, performed in the digital camera of FIG. 1, according to embodiments of the invention. In embodiments, a scene is recognized in a live view mode. However, embodiments are not limited thereto, and the scene may be recognized when a shutter is half-pressed in the live view mode.

Referring to FIG. 5, in Operation S501, the digital camera 100 receives an input image in the live view mode. In Operation S502, a scene is recognized from the input image. For example, a landscape-oriented scene and a non-landscape-oriented scene may be recognized. In Operation S503, the ratio of the input image is set based on the recognized scene. For example, the ratio of the input image at the landscape-oriented scene is set to 16:9, and the ratio of the input image at the non-landscape-oriented scene is set to 4:3. In Operation S504, if setting of the ratio of the input image is terminated, in Operation S504, the user starts photographing by completely pressing a shutter button.

FIG. 6 is a flowchart illustrating the method of setting an image aspect ratio according to scene recognition as illustrated in FIG. 5, according to embodiments of the invention.

FIG. 6 is similar to FIG. 5. However, there is a difference in that the method of FIG. 6 further includes displaying an input image on the display unit 60 based on the ratio of the input image set by the digital camera 100 of FIG. 1. The other operations are the same as those of FIG. 5 and thus, a detailed description thereof will not be provided here.

In Operation S601, an input image in a live view mode is received. In Operation S602, a scene is recognized from the input image. In Operation S603, the ratio of the input image is set based on the recognized scene. In Operation S604, the input image that is generated with the set aspect ratio is displayed on the display unit 60. In Operation S605, the user starts photographing by adjusting the type of photographing and by referring to the displayed input image in the live view mode.

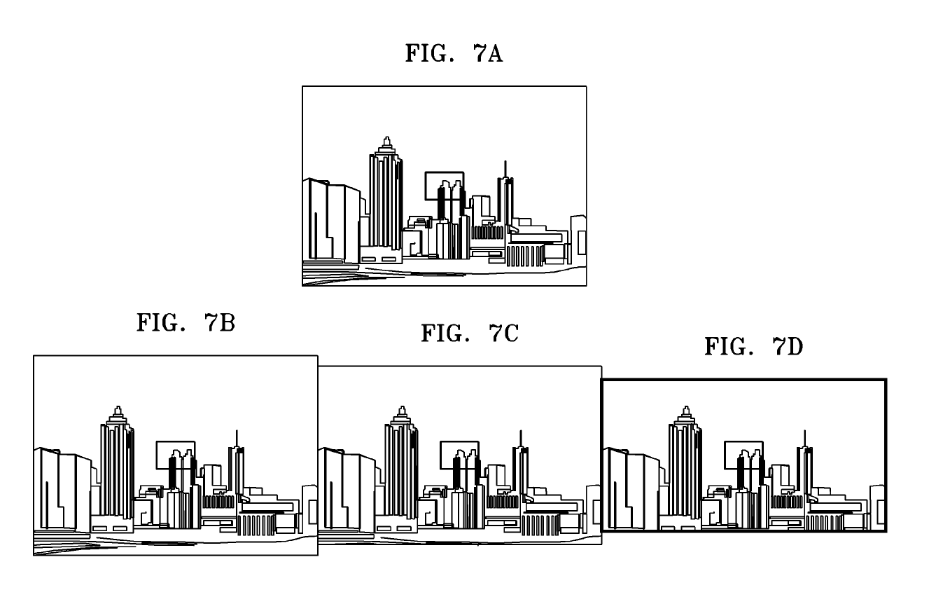

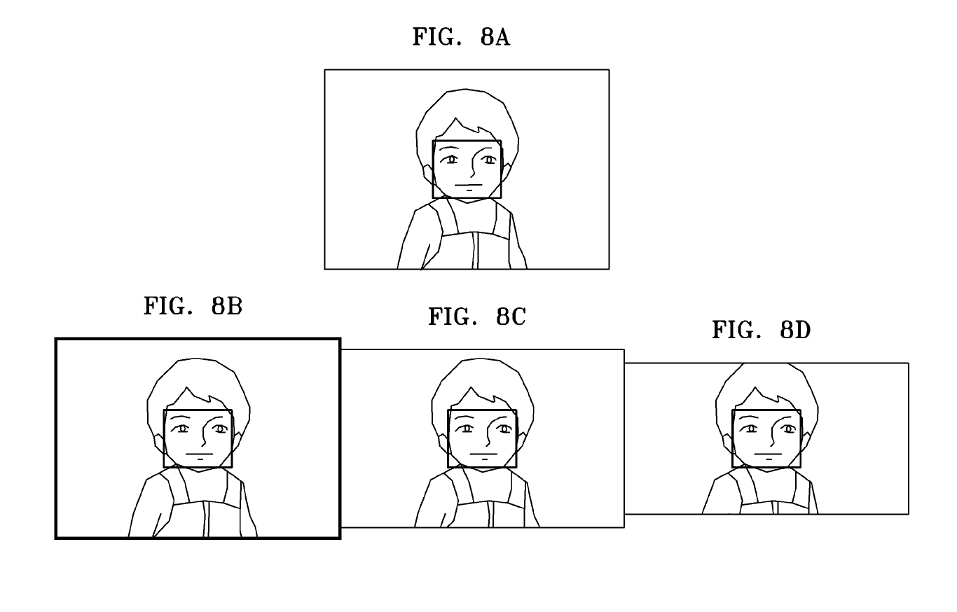

The above-described methods of setting an image aspect ratio according to scene recognition illustrated in FIGS. 5 and 6 will be described in detail below with reference to FIGS. 7A, 7B, 7C, 7D, 8A, 8B, 8C and 8D.

FIGS. 7A, 7B, 7C and 7D illustrate images having adjusted aspect ratios when a landscape-oriented scene is recognized, according to embodiments of the invention. FIG. 7A illustrates an input image. The input image illustrated in FIG. 7A may be displayed on the display unit 60 in a live view mode for scene recognition before an aspect ratio is set. FIG. 7B illustrates an image that is obtained by setting the input image illustrated in FIG. 7A at a ratio of 4:3, FIG. 7C illustrates an image that is obtained by setting the input image illustrated in FIG. 7A at an aspect ratio of 3:2, and FIG. 7D illustrates an image that is obtained by setting the input image illustrated in FIG. 7A at an aspect ratio of 16:9.

If the image of FIG. 7A is input to the digital camera 100 of FIG. 1, the digital camera 100 of FIG. 1 recognizes the input image as a landscape-oriented scene and sets the ratio of the input image to 16:9, as illustrated in FIG. 7D. If setting of the ratio of the input image is terminated, the image illustrated in FIG. 7D may be displayed on the display unit 60 in the live view mode. Also, after the user performs photographing, the image illustrated in FIG. 7D may be displayed on the display unit 60 in a quick view mode. Also, the image illustrated in FIG. 7D may be displayed on the display unit 60 in a playback mode after an image file that is generated by photographing is stored.

In this way, the digital camera 100 of FIG. 1 recognizes the scene and adjusts the ratio of an input image automatically so that the user does not need to readjust the ratio of a landscape-oriented image that may be easily viewed in wide vision and inconvenience may be removed.

FIGS. 8A, 8B, 8C and 8D illustrate images having adjusted aspect ratios when a non-landscape-oriented scene is recognized, according to embodiments of the invention. FIG. 8A illustrates an input image. The input image illustrated in FIG. 8A may be displayed on the display unit 60 in a live view mode for scene recognition before an aspect ratio is set. FIG. 8B illustrates an image that is obtained by setting the input image illustrated in FIG. 8A at an aspect ratio of 4:3, FIG. 8C illustrates an image that is obtained by setting the input image illustrated in FIG. 8A at an aspect ratio of 3:2, and FIG. 8D illustrates an image that is obtained by setting the input image illustrated in FIG. 8A at an aspect ratio of 16:9.

If the image illustrated in FIG. 8A is input to the digital camera 100 of FIG. 1, the digital camera 100 of FIG. 1 recognizes the input image as a portrait scene, i.e., as the non-landscape-oriented scene, and sets the ratio of the input image to 4:3, as illustrated in FIG. 8B. The image having a changed aspect ratio may be displayed on the display unit 60 in the live view mode before photographing or may be displayed on the display unit 60 in a quick view mode after photographing and in a playback mode after an image file that is generated by photographing is stored.

In FIGS. 7A, 7B, 7C, 7D, 8A, 8B, 8C and 8D, a scene is recognized based on the input image having an aspect ratio of 4:3, and the input image having a changed aspect ratio is generated based on the recognized scene. However, embodiments of the invention are not limited thereto, and the ratio of the image used to recognize the scene may be changed in various ways. Also, in FIGS. 7A, 7B, 7C, 7D, 8A, 8B, 8C and 8D, upper and lower portions of the input image are cut to generate an input image having an aspect ratio of 3:2 or 16:9. However, embodiments of the invention are not limited thereto, and the input image may be generated in various ways.

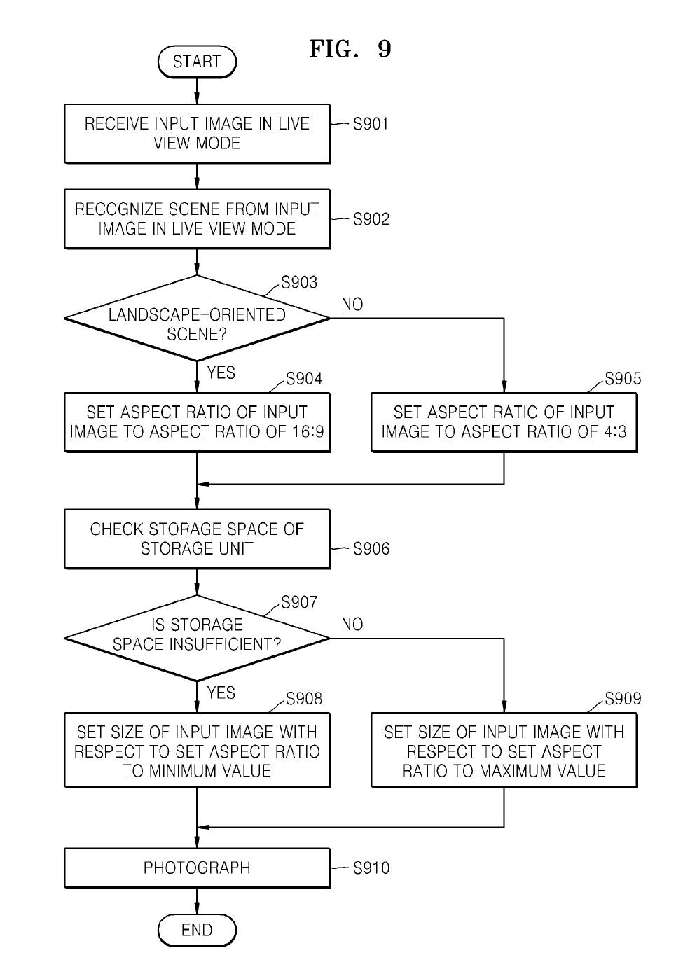

FIG. 9 is a flowchart illustrating a method of setting an image aspect ratio according to scene recognition, performed in the digital camera of FIG. 1, according to embodiments of the invention. Referring to FIG. 9, in Operation S901, an input image is received in a live view mode in a photographing standby state. However, embodiments of the invention are not limited thereto, and the input image may be received in various ways. In other embodiments, the input image for scene recognition may be input in response to a control signal that is generated by half-pressing the shutter button in the photographing standby state.

In Operation S902, the scene is recognized from the input image in the live view mode. In this case, the scene may be recognized from the input image by using edge detection of the input image, distribution of histograms according to channels of the input image or color information in a color space of the input image. In embodiments, a landscape-oriented scene such as a landscape, a night view, and backlight, and a non-landscape-oriented scene such as a portrait, a night view portrait, a backlight portrait, a macro, and a macro text may be classified and then may be recognized.

Next, when the landscape-oriented scene is recognized from the input image, in Operation S904, the ratio of the input image is set to an aspect ratio of 16:9 as wide vision. When the non-landscape-oriented scene is recognized from the input image, in Operation S905, the ratio of the input image is set to an aspect ratio of 4:3.

In this case, the ratio of the input image may be an aspect ratio of the input image displayed on the display unit 60 in the live view mode. In other embodiments, the ratio of the input image may be an aspect ratio of the image displayed on the display unit 60 in a quick view mode after photographing. Also, the ratio of the input image may be an aspect ratio of the image displayed on the display unit 60 when the image stored in the storage unit 50 after photographing is played back in the playback mode. Also, the ratio of the input image may be the ratio of an image displayed on an external monitor (not shown) when the digital camera 100 of FIG. 1 and the external monitor or a printing device (not shown) are connected to each other or may be the ratio of an image printed by the printing device.

In Operation S906, the digital camera 100 of FIG. 1 checks a storage space of the storage unit 50. In Operation S907, if it is determined that the storage space of the storage unit 50 in which an image file having a set aspect ratio is to be stored is insufficient, in Operation S908, the size of the input image with respect to the set aspect ratio is set to a minimum value. However, in Operation S907, if it is determined that the storage space of the storage unit 50 in which the image file having the set aspect ratio is to be stored is sufficient, in Operation S909, the size of the input image with respect to the set aspect ratio is set to a maximum value.

Whether the storage space of the storage unit 50 in which the image file is to be stored is sufficient may be determined by a program that has been already stored in the digital camera 100 of FIG. 1. For example, when the storage space of the storage unit 50 is less than 10%, the digital camera 100 of FIG. 1 may determine that the storage space of the storage unit 50 is insufficient and may set the size of the input image to a minimum value.

In Operation S910, the user may perform photographing after the setting of the ratio and size of the input image is completed.

However, embodiments of the invention are not limited thereto, and photographing may be performed after the set aspect ratio and the set size of the input image are checked by the display unit 60 in the live view mode. Also, after photographing is performed, as in S910, the input image may be viewed at the ratio or size of the input image that is set when the image is checked in the quick view mode or the playback mode.

According to embodiments of the invention, the digital photographing apparatus recognizes a scene in a live view mode automatically and performs photographing by changing the ratio of an input image according to the result of the scene recognition so that an image having an optimized aspect ratio may be obtained.

In particular, problems of a conventional photographing apparatus, in that a user has to change settings for each individual image before photographing or has to reset an image aspect ratio for each stored image in a playback mode after photographing, which may occur because a series of image aspect ratios is applied to all images captured by the conventional digital photographing apparatus, may be solved.

Also, a problem in that a desired aspect ratio of an image cannot be obtained because, although the aspect ratio of the image is reset in the playback mode after photographing, an aspect ratio of the image that can be changed from initial photographing is limited, may be solved.

Also, according to embodiments of the invention, the digital photographing apparatus adjusts the ratio of the input image and adjusts the size of the input image automatically based on the capacity of a storage unit so that image files may be more conveniently managed.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for embodiments the invention can be construed by programmers skilled in the art to which embodiments of the invention pertain.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While embodiments of the invention have been particularly shown and described with reference to exemplary embodiments thereof, it will be understood by those of ordinary skill in the art that various changes in form and details may be made therein without departing from the spirit and scope of embodiments of the invention as defined by the following claims.

What is claimed is:

1. A method of setting a ratio of an input image according to scene recognition, the method comprising:
generating an input image;
recognizing a scene from the input image; and
setting a ratio of the input image according to the recognized scene.

2. The method of claim 1, wherein the setting of the ratio of the input image comprises setting the ratio of the input image to an aspect ratio of 16:9 if a landscape-oriented scene is recognized.

3. The method of claim 1, wherein the setting of the ratio of the input image comprises setting the ratio of the input image to an aspect ratio of 4:3 based if a non-landscape-oriented scene is recognized.

4. The method of claim 1, further comprising displaying the input image on a display unit based on the set aspect ratio of the input image.

5. The method of claim 1, further comprising setting a size of the input image based on the set aspect ratio of the input image.

6. The method of claim 5, wherein the setting of the size of the input image comprises:
checking a storage space of a storage unit;
if it is determined that the storage space of the storage unit is sufficient, setting the size of the input image with respect to the set aspect ratio of the input image to a maximum value, and if it is determined that the storage space of the storage unit is insufficient, setting the size of the input image with respect to the set aspect ratio of the input image to a minimum value.

7. A digital photographing apparatus that sets a ratio of an input image according to scene recognition, the apparatus comprising:
an image generating unit configured to generate an input image;
a scene recognition unit configured to recognize a scene from the input image; and
an image aspect ratio setting unit configured to set an aspect ratio of the input image according to the recognized scene.

8. The apparatus of claim 7, wherein the image aspect ratio setting unit is configured to set the aspect ratio of the input image to an aspect ratio of 16:9 if a landscape-oriented scene is recognized by the scene recognition unit.

9. The apparatus of claim 7, wherein the image aspect ratio setting unit is configured to set the aspect ratio of the input image to an aspect ratio of 4:3 if a non-landscape-oriented scene is recognized by the scene recognition unit.

10. The apparatus of claim 7, further comprising a display controller configured to display the input image on a display unit based on the set aspect ratio of the input image.

11. The apparatus of claim 7, further comprising an image size setting unit configured to set a size of the input image based on the set aspect ratio of the input image.

12. The apparatus of claim 11, further comprising a storage space checking unit configured to check a storage space of a storage unit, and to set the size of the input image with respect to the aspect ratio to a maximum value if the storage space of the storage unit is sufficient, and to set the size of the input image with respect to the aspect ratio to a minimum value, if it is determined that the storage space of the storage unit is insufficient.
